(19) United States
(12) Patent Application Publication
(10) Pub. No.: US 2017/0097532 A1
(43) Pub. Date: Apr. 6, 2017

(54) LIQUID CRYSTAL DISPLAY PANEL AND LIQUID CRYSTAL DISPLAY

(71) Applicants: Shenzhen China Star Optoelectronics Technology Co., Ltd., Guangdong (CN); Wuhan China Star Optolelectronics Technology Co., Ltd., Wuhan, Hubei (CN)

(72) Inventor: Yuejun TANG, Guangdong (CN)

(21) Appl. No.: 14/779,203

(22) PCT Filed: Aug. 14, 2015
(86) PCT No.: PCT/CN2015/086954

§ 371 Date: Sep. 22, 2015

(30) Foreign Application Priority Data
Apr. 29, 2015 (CN) 201510213906.6

(51) Int. Cl. G02F 1/1339; G02F 1/1335

(52) U.S. Cl. CPC G02F 1/13394; G02F 1/133512; G02F 1/133514; G02F 2001/13398; G02F 2001/13396; G02F 1/1368

(57) ABSTRACT

A liquid crystal display panel is provided, including a first substrate; a second substrate disposed opposite to the first substrate; black matrixs formed on the first substrate; a color filter layer formed on the black matrixs. A main photo spacers is formed on the color filter layer and disposed under the black matrixs; wherein a first groove is formed on each of the main photo spacers, and a bump corresponding to the first groove is provided on the second substrate, and the bump is disposed in the first groove. A liquid crystal display including the liquid crystal display panel is also provided. With the present disclosure, damage to main photo spacers for overcompression may be avoided, and a mismatching of the first and second substrates may also be avoided, to thereby prevent light leaking of the liquid crystal display panel.

### TECHNICAL FIELD

The present disclosure belongs to liquid crystal display field, and more particularly, relates to a liquid crystal display panel and a liquid display.

### BACKGROUND ART

With development of photoelectricity and semiconductor technology, has led to a growth in the booming of flat panel display. In numerouss flat display panels, liquid crystal display (LED for short) becomes the mainstream market for its favorable characteristics such as high efficient in space utilization, low power consumption, radiationless and low disturbance of electromagnetism etc.

FIG. 1 is a structural diagram of a liquid crystal display in the existing technology. Refer to FIG. 1, a liquid crystal display 1 usually includes a backlight module 2 and a liquid crystal display panel 3 disposed opposite to the backlight module 2. The liquid crystal display panel 3 cannot emit light itself, thus it needs a display light source provided by the backlight module 2. The liquid crystal display panel 3 displays images by means of the display light source provided by the backlight module 2.

The liquid display panel 3 usually includes a thin film transistor array (TFT) substrate 31 and a color filter (CF) substrate 32 which are opposite to each other for cells, and a liquid crystal layer 33 interposed between the TFT substrate 31 and the CF substrate 32. In order to support and maintain a gap between the TFT substrate 31 and the CF substrate 32, in general, a plurality of main photo spacers 321 contacting the TFT substrate 31 and a plurality of sub photo spacers 322 without touching the TFT substrate 31 are formed on the CF substrate, and the distribution density of the main photo spacers 321 is lower than that of the sub photo spacers 322.

When the liquid crystal display panel 3 is under a uniform large-scale pressure, the main photo spacers 321 are compressed to have the same height as that of the sub photo spacers 322, by this time, the sub photo spacers 322 with large density begin to share the pressure, but when the liquid crystal display panel 3 is under a nonuniform pressure, especially to the nonuniform pressure on one point of the liquid crystal display panel 3 (e.g., the nonuniform pressure generated in grinding process and dynamic pressure test after thinning), a single main photo spacer 321 may be highly compressed under too much pressure thereby being damaged. Moreover, when the liquid crystal display panel 3 is under a lateral thrust pressure, the TFT substrate 31 and the CF substrate 32 may easily mismatch with each other, thereby causing a light leaking

### SUMMARY

In order to solve the above problem existing in the prior art, the present disclosure aims to provide liquid crystal display panel including: a first substrate; a second substrate disposed opposite to the first substrate; black matrixs formed on the first substrate; a color filter layer formed on the black matrixs; and main photo spacers formed on the color filter layer and disposed under the black matrixs, wherein a first groove is formed on each of the main photo spacers, and a bump corresponding to the first groove is provided on the second substrate, and the bump is disposed in the first groove.

Further, a second groove at a side of the bump is provided on the second substrate, and the second groove corresponds to a first bump at a side of the first groove.

Further, the first bump does not contact the second substrate.

Further, a third groove at other side of the bump is also provided on the second substrate, and the third groove corresponds to a second bump at other side of the first groove.

Further, the second bump does not contact the second substrate.

Further, the liquid crystal display panel also includes sub photo spacers, which are formed on the color filter layer with the main photo spacers alternately, and the sub photo spacers are located under the black matrixs.

Further, the sub photo spacers do not contact the second substrate.

Further, fourth groove are also provided on the second substrate, and the fourth grooves correspond to the sub photo spacers.

The present disclosure also provides a liquid crystal display including a backlight module and the above mentioned liquid crystal display panel disposed opposite to the backlight module, wherein the backlight module provides a display light source to the liquid crystal display panel, such that the liquid crystal display panel displays images.

With respect to the liquid crystal display panel and the liquid crystal display in the present disclosure, when the liquid crystal display panel is under a pressure, damage to main photo spacers for overcompression may be avoided; and when the liquid crystal display panel is under a lateral pressure, mismatching of the first substrate and the second substrate may be avoided, to thereby prevent light leaking of the liquid crystal display panel.

### BRIEF DESCRIPTION OF THE DRAWINGS

The above and other aspects, characteristics and advantages of the embodiments of the disclosure will become apparent from the following description, taken in conjunction with the accompanying drawings in which:

FIG. 1 is a structural schematic diagram of a liquid crystal display of the existing technology;

FIG. 2 is a side view of a liquid crystal display panel according to an embodiment of the present disclosure;

FIG. 3 is a state diagram of the liquid crystal display panel under a positive pressure as shown in FIG. 2;

FIG. 4 is a state diagram of the liquid crystal display panel under an oblique pressure as shown in FIG. 2;

FIG. 5 is a side view of the liquid crystal display panel according to another embodiment of the present disclosure;

FIG. 6 is a state diagram of the liquid crystal display panel under a positive pressure as shown in FIG. 5;

FIG. 7 is a state diagram of the liquid crystal display panel under an oblique pressure as shown in FIG. 5; and

FIG. 8 is a structural schematic diagram of a liquid crystal display according to an embodiment of the present disclosure.

### DETAILED DESCRIPTION OF EXEMPLARY EMBODIMENTS

Embodiments of the present disclosure will be described in detail below by referring to the accompany drawings. However, the present disclosure can be implemented in numerous different forms and should not be construed as being limited to the particular embodiments elaborated herein. Instead, these embodiments are provided for explaining the principle and actual application of the present invention, thus other skilled in the art might understand various embodiments and amendments which are suitable for specific intended applications of the present disclosure. In the drawings, for clearness of devices, thicknesses of layers and regions are exaggerated, and the same reference numberals can be used to represent the same elements throughout the description and drawings. It will be understood that a layer or an element can directly form “on” other layer or substrate, or there also exist a intermediate layer, when the layer or the element is refered to as forming on other layer or substrate.

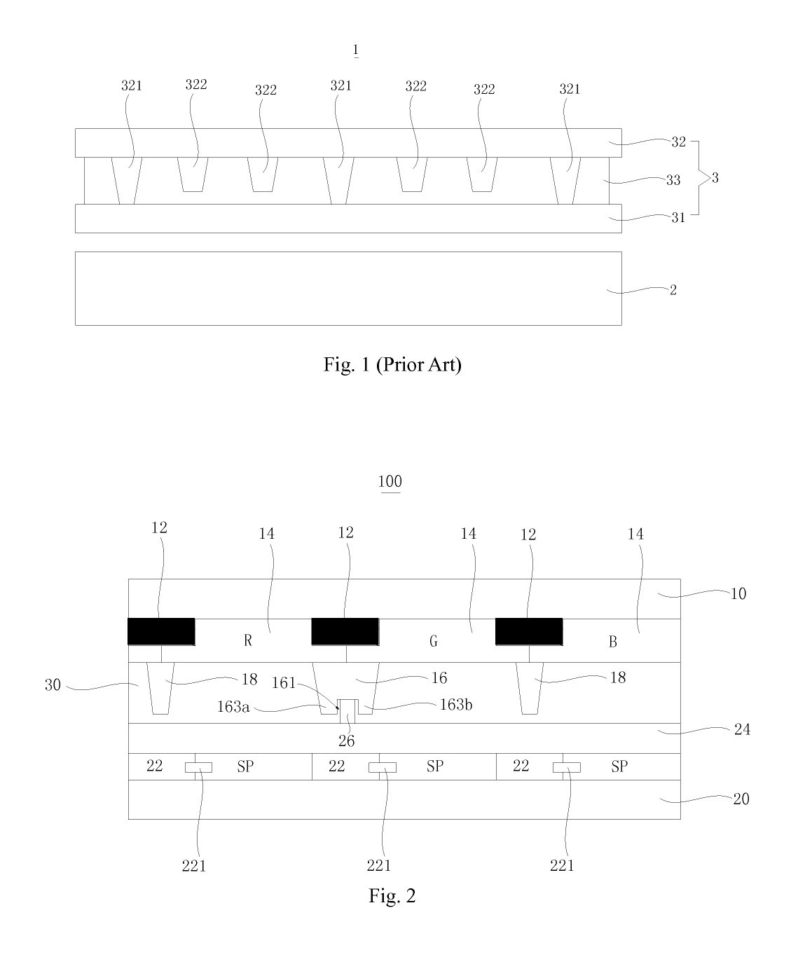

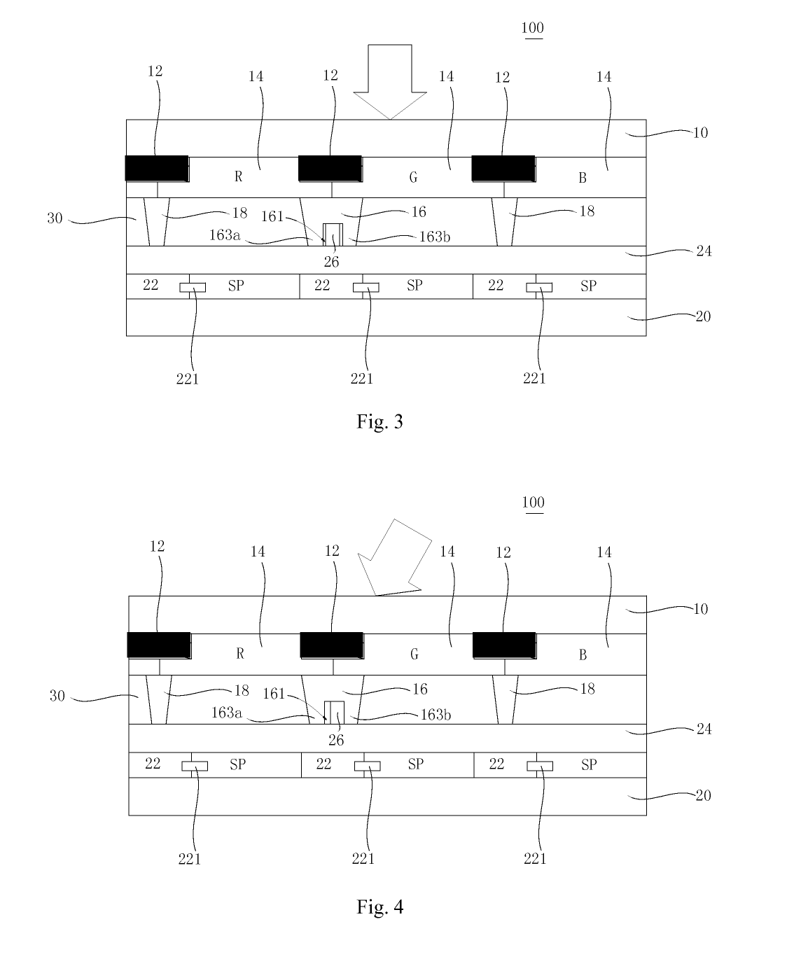

FIG. 2 is a side view of a liquid crystal display panel according to an embodiment of the present disclosure. FIG. 3 is a state diagram of the liquid crystal display panel under a positive pressure as shown in FIG. 2. FIG. 4 is a state diagram of the liquid crystal display panel under an oblique pressure as shown in FIG. 2.

Referring to FIG. 2, the liquid crystal display panel 100 according to an embodiment of the present disclosure at least includes a first substrate 10 and a second substrate 20 opposite to each other for cells, and a liquid crystal layer 30 interposed between the first substrate 10 and the second substrate 20 and including several liquid crystal molecules.

A display region of the second substrate includes a plurality of sub-pixel regions SP, and several switch tubes (e.g., thin film transistor) 22 arranged in an array are provided on the second substrate 20, and a pixel electrode 221 of each switch tube 22 is disposed in the corresponding sub-pixel region SP thereof. An insulating layer 24 is also provided on the second substrate 20, and the insulating layer 24 covers all switch tubes 22 and all sub-pixel regions SP completely. Bumps 26 disposed on the insulating layer 24 will be described in details below.

On the first substrate 10 is at least provided with black matrixs 12, a color filter layer 14 and main photo spacers (MPSs) 16. It should be explained that other elements of appropriate types can also be provided on the first substrate 10 in accordance with different modes of the liquid crystal display panel. The number of the main photo spacers 16 is not limited to that shown in the drawings, which can be set to any number according to requirements.

The black matrixs (BMs) 12 are formed on the first substrate 10 and can be made of black resin or metal chromium. The switch tubes 22 formed on the second substrate 20 is directly facing the black matrixs 12. The color filter layer 14 is formed on the first substrate 10 and covers the black matrix 12s, where the color filter layer 14 includes a red (R) color blocking layer, a green (G) color blocking layer and a blue (B) color blocking layer formed sequentially.

The main photo spacers 16 are formed on the color filter layer 14 and disposed under the black matrixs 12 alternately. The bumps 26 on the second substrate 20 correspond to the main photo spacers 16 one by one. A first groove 161 is formed on each of the main photo spacers 16, each of bumps 26 is disposed in the corresponding first groove 161, while a first bump 163a and a second bump 163b at both sides of the first groove 161 of each of the main photo spacers 16 do not contact the second substrate 20.

In addition, sub photo spacers (SPS) 18 are also disposed on the first substrate 10. The sub photo spacers 18 and the main photo spacers 16 are formed on the color filter layer 14 alternately, and the sub photo spacers 18 is also located under the black matrixs 12. When the first substrate 10 and the second substrate 20 are opposite to each other for cells, the sub photo spacers 18 do not contact the second substrate 20. The number of the sub photo spacers 18 is not limited to that shown in the drawings, which can be set to any number according to requirements.

Referring to FIG. 3, when the liquid crystal display panel 100 according to an embodiment of the present disclosure is under a positive pressure (which is shown by an arrow pointing downward in the drawings), the first bump 163a and the second bump 163b at both sides of the first groove 161 on the main photo spacer 16 can contact both sides of each the bumps 26 on the second substrate 20 timely, such that the compression area of the main photo spacers 16 is enlarged, and the main photo spacers may not be damaged for overcompression.

Referring to FIG. 4, when the liquid crystal display panel 100 according to an embodiment of the present disclosure is under a lateral pressure (which is shown by an arrow pointing slantingly downwards), the first grooves 161 of the main photo spacers 16 are engaged with the bumps 26 on the second substrate 20 respectively, to thereby avoid mismatching of the first substrate 10 and the second substrate 20, and prevent the liquid crystal display panel 100 from light leaking

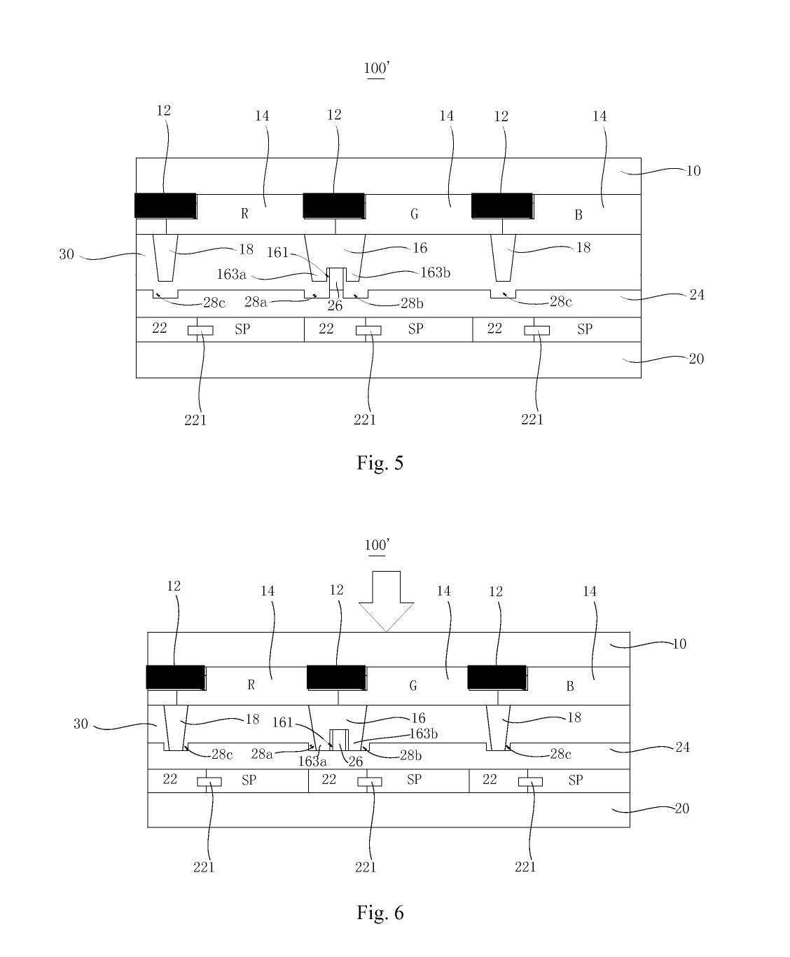

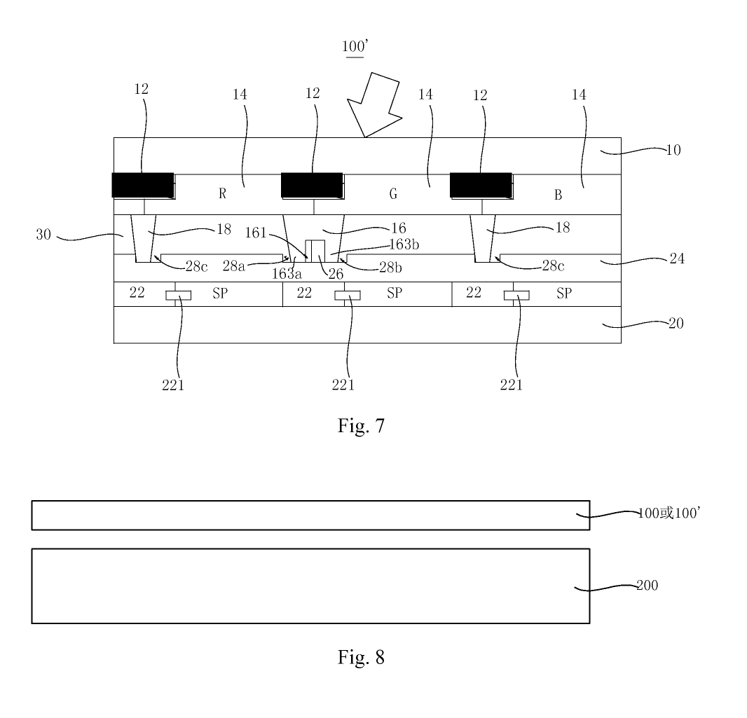

FIG. 5 is a side view of the liquid crystal display panel according to another embodiment of the present disclosure. FIG. 6 is a state diagram of the liquid crystal display panel under a positive pressure as shown in FIG. 5. FIG. 7 is a state diagram of the liquid crystal display panel under an oblique pressure as shown in FIG. 5.

Referring to FIG. 5, the liquid crystal display panel 100′ shown in FIG. 5 differs from the liquid crystal display panel 100 shown in FIG. 2 in: a second groove 28a and a third groove 28b at both sides of each of the bumps 26 are further provided on the second substrate 20, and the second groove 28a corresponds to the first bump 163a at a side of each of the first grooves 161, while the third groove 28b corresponds to the second bump 163b at other side of each of the first grooves 161.

Further, fourth grooves 28c are also provided on the second substrate 20, and the fourth grooves 28c correspond to the sub photo spacers 18 one by one.

Referring to FIG. 6, when the liquid crystal display panel 100′ according to an embodiment of the present disclosure is under a positive pressure (which is shown by an arrow pointing downward in the drawings), the first bump 163a and the second bump 163b at both sides of the first groove 161 of each of the main photo spacers 16 contact the second substrate 20 through the second groove 28a and the third groove 28b, respectively, such that the compression area of the main photo spacers 16 is enlarged, and the main photo spacers may not be easily damaged for overcompression.

Referring to FIG. 7, when the liquid crystal display panel 100′ according to an embodiment of the present disclosure is under a lateral pressure (which is shown by an arrow pointing slantingly downwards), the first grooves 161 of the main photo spacers 16 are engaged with the bumps 26 on the second substrate 20, the first bump 163a and the second bump 163b are engaged with the

English Translation second groove 28a and the third groove 28b, respectively, and the sub photo spacers 18 are engaged with the fourth grooves 28c, to thereby avoid mismatching of the first substrate 10 and the second substrate 20, and prevent the liquid crystal display panel 100′ from light leaking

FIG. 8 is a structural schematic diagram of a liquid crystal display according to an embodiment of the present disclosure.

Referring to FIG. 8, a liquid crystal display according to an embodiment of the present disclosure includes a backlight module 200 and a liquid crystal display panel 100 shown in FIG. 2 or a liquid crystal display panel 100′ shown in FIG. 5 disposed opposite to the backlight module 200. The liquid crystal display panel 100 shown in FIG. 2 or the liquid crystal display panel 100′ shown in FIG. 5 cannot emit light itself, thus it needs a display light source provided by the backlight module 200. The liquid crystal display panel 100 shown in FIG. 2 or the liquid crystal display panel 100′ shown in FIG. 5 displays images by means of the display light source provided by the backlight module 200.

Although the present disclosure is described with reference to the special exemplary embodiment, it will be understood by those skilled in the art that: various changes in form and details may be made therein without departing from the spirit and scope of the disclosure as defined by the appended claims and its equivalents.

1. A liquid crystal display panel, comprising:
a first substrate;
a second substrate disposed opposite to the first substrate;
black matrixs formed on the first substrate;
a color filter layer formed on the black matrixs; and
main photo spacers formed on the color filter layer and disposed under the black matrix;
wherein a first groove is formed on each of the main photo spacers, and a bump corresponding to the first groove is provided on the second substrate, and the bump is disposed in the first groove.

2. The liquid crystal display panel of claim 1, wherein a second groove at a side of the bump is provided on the second substrate, and the second groove corresponds to a first bump at a side of the first groove.

3. The liquid crystal display panel of claim 2, wherein the first bump does not contact the second substrate.

4. The liquid crystal display panel of claim 2, wherein a third groove at the other side of the bump is also provided on the second substrate, and the third groove corresponds to a second bump at the other side of the first groove.

5. The liquid crystal display panel of claim 4, wherein the second bump does not contact the second substrate.

6. The liquid crystal display panel of claim 1, wherein the liquid crystal display panel also comprises sub photo spacers, which are formed on the color filter layer with the main photo spacers alternately, and the sub photo spacers are located under the black matrixs.

7. The liquid crystal display panel of claim 6, wherein the sub photo spacers do not contact the second substrate.

8. The liquid crystal display panel of claim 7, wherein fourth grooves are also provided on the second substrate, and the fourth grooves correspond to the sub photo spacers.

9. A liquid crystal display, comprising: a backlight module and a liquid crystal display panel disposed opposite to the backlight module, the backlight module providing a display light source to the liquid crystal display panel, such that the liquid crystal display panel displays images, wherein the liquid crystal display panel comprises:
a first substrate;
a second substrate disposed opposite to the first substrate;
black matrixs formed on the first substrate;
a color filter layer formed on the black matrixs; and
main photo spacers formed on the color filter layer and disposed under the black matrixs;
wherein a first groove is formed on each of the main photo spacers, and a bump corresponding to the first groove is provided on the second substrate, and the bump is disposed in the first groove.

10. The liquid crystal display of claim 9, wherein a second groove at a side of the bump is provided on the second substrate, and the second groove corresponds to a first bump at a side of the first groove.

11. The liquid crystal display of claim 10, wherein the first bump does not contact the second substrate.

12. The liquid crystal display of claim 10, wherein a third groove at the other side of the bump is also provided on the second substrate, and the third groove corresponds to a second bump at the other side of the first groove.

13. The liquid crystal display of claim 12, wherein the second bump does not contact the second substrate.

14. The liquid crystal display of claim 9, wherein the liquid crystal display panel also comprises sub photo spacers, which are formed on the color filter layer with the main photo spacers alternately, and the sub photo spacers are located under the black matrixs.

15. The liquid crystal display of claim 14, wherein the sub photo spacers do not contact the second substrate.

16. The liquid crystal display of claim 15, wherein fourth grooves are also provided on the second substrate, and the fourth grooves correspond to the sub photo spacers.
